(19) United States
(12) Patent Application Publication
(10) Pub. No.: US 2013/0152348 A1
(43) Pub. Date: Jun. 20, 2013

(54) Method for Permanently Sealing Animal Cremains (Ashes) in Capsule imbedded within Plush Receptacle

(71) Applicant: Mark Wayne Taylor, Birmingham, AL (US)

(72) Inventor: Mark Wayne Taylor, Birmingham, AL (US)

(21) Appl. No.: 13/326,369

(22) Filed: Dec. 15, 2011

(51) Int. Cl. A61G 17/08; E04H 13/00

(52) U.S. Cl. CPC A61G 17/08; E04H 13/008
USPC 27/1; 40/124.5

(57) ABSTRACT

Method of permanently sealing cremains of pet in a clear material (nonvolatile, organic substance, consisting of amorphous mixtures of carboxylic acids or similar substance), with a tag or label showing the animal's name, birth and death dates, as well as family (owner) name and possibly a small photo of the deceased animal (herein known as the “capsule”). The capsule can be made in varying sizes, depending on the amount of cremains. The completed capsule will be unbreakable, completely sealed and cannot be reversed once molded and cured. This will serve to ensure the cremains will never be in danger of being scattered or spilled due to mishandling or accident. This capsule is then imbedded in a plush receptacle, which can be in the likeness of the deceased animal or any other form available, such as a dragon, unicorn or teddy bear.

### FIELD OF THE INVENTION

This invention relates to personalized urns for the cremated remains of pets.

### BACKGROUND OF THE INVENTION

Someone who loses a beloved pet often needs to memorialize the strong emotional bond resulting from love or friendship. Although standard urns for holding ashes do memorialize a deceased pet, the effect is often not sufficient for those who wish a more personalized tribute, such as something that can be held and/or even resembles the pet. This invention provides urns which meet that need, in that the pet's cremains are placed into a receptacle that is cuddly and/or reminiscent of the deceased pet.

### SUMMARY OF THE INVENTION

This invention provides a receptacle for storing the ashes (cremated remains) of a deceased person or a pet. The receptacle includes a capsule comprised of the cremains in a clear material (nonvolatile, organic substance, consisting of amorphous mixtures of carboxylic acids or similar substance, herein known as “sealing substance”), to which a tag or label is imbedded, so as to be clearly visible, between the cremains/sealing substance and a clear layer of sealing substance.

This serves two purposes: first, it ensures the owner knows that it is, in fact, their pets' ashes that are contained therein; and second, it provides a permanent written memorial to the pet.

This capsule can be sealed inside a plush receptacle chosen by the owner. The receptacle can be a plush animal that resembles the deceased or something more whimsical, such as a dragon, unicorn or teddy bear.

### DETAILED DESCRIPTION OF THE INVENTION

First, the cremains of a pet are mixed with just enough sealing substance to completely wet the ashes. This is then poured into a capsule mold of appropriate size. This size will be large enough to contain all of the cremains/sealing substance. Once cured, a tag or label is printed with the pets name, birth and death dates, as well as the family (owner) name and possibly a photo of the deceased pet. This tag/label is placed on the capsule. The capsule is then inserted into a mold that is slightly larger and sealing substance is poured in which creates a clear outer layer, allowing the tag or label to be completely visible when cured.

This capsule can then be imbedded inside a plush receptacle, chosen by the owner. The receptacle can be a plush dog that resembles the deceased or something more whimsical, such as a dragon, unicorn or teddy bear.

What is claimed is:

1. Combining cremains of a deceased pet with clear material (nonvolatile, organic substance, consisting of amorphous mixtures of carboxylic acids or similar substance) and molding into a capsule. The size of the capsule will depend upon the amount of cremains and the plush animal selected.

2. Inside the capsule, a tag or label is sealed, so as to be clearly visible, between the cremains/clear material and a clear layer of the material. Tag or label can contain the name, birth and death dates of the pet, as well as the family (owner) name, and possibly a small photo. This inclusion will serve to ensure that the correct cremains go to the right owner and will also allow identification of the contents should the plush receptacle be damaged or destroyed.

3. Cremains capsule is imbedded inside a plush receptacle of the family's choosing.
